(19) United States
(12) Patent Application Publication
(10) Pub. No.: US 2026/0371194 A1
(43) Pub. Date: Nov. 19, 2026

(54) VIRTUAL CELL RESELECTION MEASUREMENTS

(71) Applicant: QUALCOMM Incorporated, San Diego, CA (US)

(72) Inventors: Aria HASANZADEZONUZY, Chatham, NJ (US); Kianoush HOSSEINI, San Diego, CA (US); Umesh PHUYAL, San Diego, CA (US)

(21) Appl. No.: 19/209,314

(22) Filed: May 15, 2025

(51) Int. Cl. H04W 36/00

(52) U.S. Cl. CPC H04W 36/0085

(57) ABSTRACT

This disclosure provides methods, components, devices and systems for virtual cell reselection measurements. For example, this may include configuring a user equipment (UE) with regards to which subband(s) (SB)(s), cell(s), and/or component carrier(s) (CC)(s) of a virtual cell to measure. For example, the network may transmit a signal to the UE that identifies a measurement configuration for the UE. The measurement configuration may identify a subset of the SB(s), cell(s), and/or CC(s) associated with a virtual cell that the UE is to measure. The SB(s), cell(s), and/or CC(s) associated with the virtual cell may be associated via a common virtual cell identifier. The UE may perform the channel measurement procedure on the virtual cell according to the measurement configuration and while operating in an inactive or idle mode. The UE may transmit a feedback report that indicates the results of the virtual cell measurement procedure.

### TECHNICAL FIELD

This disclosure relates generally to wireless communication, and more specifically to systems, devices, methods, and techniques associated with virtual cell reselection measurements.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a UE is described. The method may include receiving a signal that identifies a measurement configuration for the UE, the measurement configuration identifying a subset of subbands, cells, or component carriers (CCs) that are to be measured while the UE is operating in an idle or inactive mode, where the subset of subbands, cells, or CCs are associated with a virtual cell through a common virtual cell identifier, performing a virtual cell measurement procedure for the virtual cell while operating in the idle or inactive mode according to the measurement configuration, and transmitting a feedback report that indicates a result of the virtual cell measurement procedure.

A UE for wireless communications is described. The UE may include one or more memories storing processor-executable code and one or more processors coupled (e.g., directly, indirectly, without pre-processing, after pre-processing) with the one or more memories and individually or collectively operable to execute the code to cause the UE to receive a signal that identifies a measurement configuration for the UE, the measurement configuration identifying a subset of subbands, cells, or CCs that are to be measured while the UE is operating in an idle or inactive mode, where the subset of subbands, cells, or CCs are associated with a virtual cell through a common virtual cell identifier, perform a virtual cell measurement procedure for the virtual cell while operating in the idle or inactive mode according to the measurement configuration, and transmit a feedback report that indicates a result of the virtual cell measurement procedure.

Another UE for wireless communications is described. The UE may include means for receiving a signal that identifies a measurement configuration for the UE, the measurement configuration identifying a subset of subbands, cells, or CCs that are to be measured while the UE is operating in an idle or inactive mode, where the subset of subbands, cells, or CCs are associated with a virtual cell through a common virtual cell identifier, means for performing a virtual cell measurement procedure for the virtual cell while operating in the idle or inactive mode according to the measurement configuration, and means for transmitting a feedback report that indicates a result of the virtual cell measurement procedure.

A non-transitory computer-readable medium storing code for wireless communications is described. The code may include instructions executable by one or more processors to receive a signal that identifies a measurement configuration for the UE, the measurement configuration identifying a subset of subbands, cells, or CCs that are to be measured while the UE is operating in an idle or inactive mode, where the subset of subbands, cells, or CCs are associated with a virtual cell through a common virtual cell identifier, perform a virtual cell measurement procedure for the virtual cell while operating in the idle or inactive mode according to the measurement configuration, and transmit a feedback report that indicates a result of the virtual cell measurement procedure.

In some examples of the method, user equipment (UEs), and non-transitory computer-readable medium described herein, the measurement configuration identifies the subset of subbands, cells, or CCs according to a group identifier.

Some examples of the method, user equipment (UEs), and non-transitory computer-readable medium described herein may further include operations, features, means, or instructions for transmitting a message that identifies one or more subbands, cells, or CCs associated with the virtual cell for measurement, where the one or more subbands, cells, or CCs may be included in the subset of subbands, cells, or CCs identified in the signal based on the one or more subbands, cells, or CCs being included in the message.

In some examples of the method, user equipment (UEs), and non-transitory computer-readable medium described herein, the signal may be received in a system information block two (SIB2) message, in a system information block three (SIB3) message, or in a system information block four (SIB4) message from a single carrier serving cell and the virtual cell includes a non-serving neighboring cell.

A method for wireless communications by a network entity is described. The method may include transmitting, to a UE, a signal that identifies a measurement configuration for the UE, the measurement configuration identifying a subset of subbands, cells, or CCs that are to be measured while the UE is operating in an idle or inactive mode, where the subset of subbands, cells, or CCs are associated with a virtual cell through a common virtual cell identifier and receiving, from the UE, a feedback report that indicates a result of a virtual cell measurement procedure performed for the virtual cell while the UE operates in the idle or inactive mode according to the measurement configuration.

A network entity for wireless communications is described. The network entity may include one or more memories storing processor-executable code and one or more processors coupled (e.g., directly, indirectly, without pre-processing, after pre-processing) with the one or more memories and individually or collectively operable to execute the code to cause the network entity to transmit, to a UE, a signal that identifies a measurement configuration for the UE, the measurement configuration identifying a subset of subbands, cells, or CCs that are to be measured while the UE is operating in an idle or inactive mode, where the subset of subbands, cells, or CCs are associated with a virtual cell through a common virtual cell identifier and receive, from the UE, a feedback report that indicates a result of a virtual cell measurement procedure performed for the virtual cell while the UE operates in the idle or inactive mode according to the measurement configuration.

Another network entity for wireless communications is described. The network entity may include means for transmitting, to a UE, a signal that identifies a measurement configuration for the UE, the measurement configuration identifying a subset of subbands, cells, or CCs that are to be measured while the UE is operating in an idle or inactive mode, where the subset of subbands, cells, or CCs are associated with a virtual cell through a common virtual cell identifier and means for receiving, from the UE, a feedback report that indicates a result of a virtual cell measurement procedure performed for the virtual cell while the UE operates in the idle or inactive mode according to the measurement configuration.

A non-transitory computer-readable medium storing code for wireless communications is described. The code may include instructions executable by one or more processors to transmit, to a UE, a signal that identifies a measurement configuration for the UE, the measurement configuration identifying a subset of subbands, cells, or CCs that are to be measured while the UE is operating in an idle or inactive mode, where the subset of subbands, cells, or CCs are associated with a virtual cell through a common virtual cell identifier and receive, from the UE, a feedback report that indicates a result of a virtual cell measurement procedure performed for the virtual cell while the UE operates in the idle or inactive mode according to the measurement configuration.

In some examples of the method, network entities, and non-transitory computer-readable medium described herein, the measurement configuration identifies the subset of subbands, cells, or CCs according to a group identifier.

Some examples of the method, network entities, and non-transitory computer-readable medium described herein may further include operations, features, means, or instructions for receiving, from the UE, a message that identifies one or more subbands, cells, or CCs associated with the virtual cell for measurement, where the one or more subbands, cells, or CCs may be included in the subset of subbands, cells, or CCs identified in the signal based on the one or more subbands, cells, or CCs being included in the message.

### BRIEF DESCRIPTION OF THE DRAWINGS

FIG. 1 shows an example of a wireless communication system.

FIG. 2 shows an example of a signaling diagram that supports virtual cell reselection measurements.

FIG. 3 shows an example of a signaling diagram that supports virtual cell reselection measurements.

FIG. 4 shows an example of a timing diagram that supports virtual cell reselection measurements.

FIG. 5 shows a block diagram of a processing system that supports virtual cell reselection measurements.

FIG. 6 shows a diagram of a system including a device that supports virtual cell reselection measurements.

FIG. 7 shows a block diagram of a processing system that supports virtual cell reselection measurements.

FIG. 8 shows a diagram of a system including a device that supports virtual cell reselection measurements.

FIGS. 9 and 10 show flowcharts illustrating methods that support virtual cell reselection measurements.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, virtual cell(s) (vCell)(s) may be defined for user equipment (UE), such as to support carrier aggregation (CA) operations. In some networks, a UE configured with CA operations may be configured with a set of cells where each cell is associated with a component carrier (CC). The vCell(s), instead, may include a “cell” being assigned to the UE where the “cell” is associated with subband(s) (SB)(s), cell(s), and/or CC(s). Moreover, the SB(s) and/or CC(s) of a vCell may include different frequency ranges, such as frequency range one (FR1), frequency range two (FR2), frequency range three (FR3), and so on. However, in such wireless networks a UE attempting to connect to a vCell and/or already connected to a vCell may result in the UE performing channel measurements on every SB, cell, and/or CC of the vCell. Such wireless networks may not provide a mechanism to configure the UE with individual or a subset of the SB(s), cell(s), and/or CC(s) of a vCell to measure.

Aspects of the subject matter described in this disclosure relate to configuring the UE with regards to which SB(s), cell(s), and/or CC(s) of a vCell to measure. The UE may perform the channel measurements for the configured SB(s), cell(s), and/or CC(s) of the vCell while operating in a radio resource control (RRC) inactive or idle mode or state. For example, the network may transmit or otherwise output (and the UE may receive or otherwise obtain) a signal that identifies a measurement configuration for the UE. The measurement configuration may identify a subset (e.g., one or more than one) of the SB(s), cell(s), and/or CC(s) associated with a vCell that the UE is to measure (e.g., while the UE is operating in the RRC idle or inactive mode). As one example, the SB(s), cell(s), and/or CC(s) associated with the vCell may be associated via a common vCell identifier (ID). The UE may perform the channel measurement procedure (e.g., a vCell measurement procedure) on the vCell according to the measurement configuration. For example, the UE may measure various reference signal(s) (RS)(s) being transmitted via the vCell (e.g., in one or more of the SB(s), cell(s), and/or CC(s) of the virtual cell). The vCell in this example may be a serving cell that the UE is connected to or may be a candidate or neighboring vCell that the UE may attempt to perform a channel access procedure with. The UE may transmit a feedback report that indicates the results of the vCell measurement procedure.

Particular aspects of the subject matter described in this disclosure can be implemented to realize one or more of the following potential advantages. In some examples, by configuring the UE with which (e.g., the subset) SB(S), cell(s), and/or CC(s) are to be measured, the described techniques can be used to reduce the latency associated with the UE connecting with the vCell. Dividing the SB(s), cell(s), and/or CC(s) into the subset for channel measurement may reduce the power consumption of the UE as it does not have to measure every SB, cell, and/or CC of the vCell.

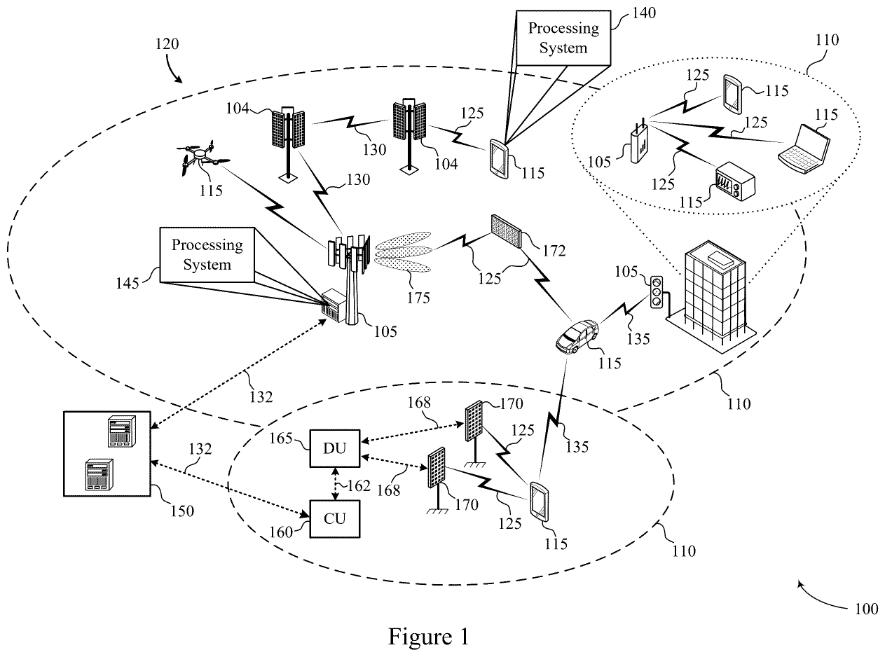

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for virtual cell reselection measurements. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the wireless communication system 100 (such as the RAN 120) may support configuring a subset of SB(s), cell(s), and/or CC(s) of a vCell for measurement by a UE 115. This approach may enable to the UE 115 to perform channel measurements on a subset of the SB(s), cell(s), and/or CC(s) of the vCell.

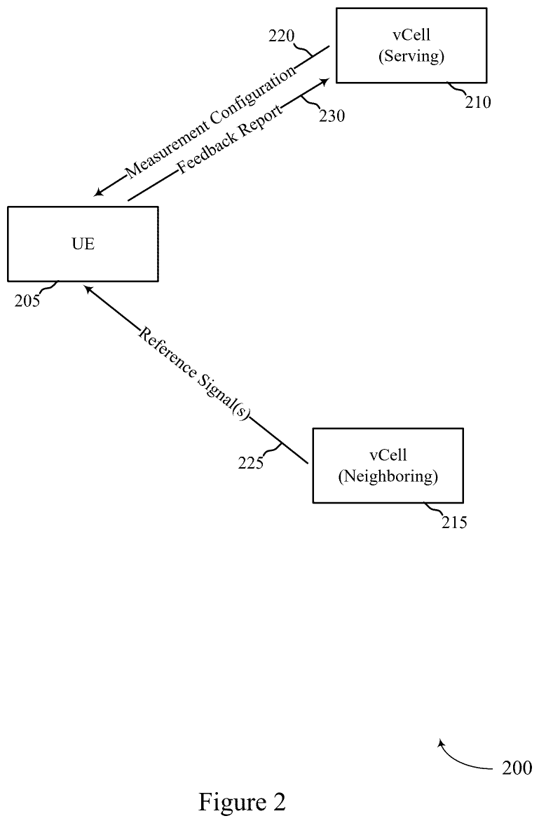

FIG. 2 shows an example of a signaling diagram 200 that supports vCell reselection measurements. Aspects of the signaling diagram 200 may be implemented at and/or may be implemented by aspects of the wireless communication system 100. Aspects of the signaling diagram 200 may be implemented at and/or implemented by a UE 205, a vCell 210, and/or a vCell 215, which may be examples of the corresponding devices described herein. In some cases, the vCell 210 may be considered a serving cell of the UE 205 while the vCell 215 may be considered a neighboring cell (e.g., a candidate cell) of the UE 205.

Some wireless networks, such as Sixth Generation (6G) networks, may operate according to service-based access techniques, where resources are allocated based on different application/service needs for the UE. For example, in the context of a 6G network, a UE may attach, connect, or “subscribe” to a set of cells for different applications or services, such as authentication services, gaming services, or a variety of other services. In order to support such service-based access, such wireless networks may implement the concept of a vCell, which may include (e.g., be composed of) multiple serving cells, multiple SBs, multiple CCs, and/or multiple portions of a sub-band, that form the vCell based on a common vCell identifier. In such cases, the respective serving cells of a vCell may be grouped together to facilitate wireless communications for one or more applications/services (e.g., an “authentication” vCell that includes multiple serving cells that are grouped together to facilitate wireless communications for authentication services). By connecting with a vCell, the UE may communicate with multiple serving cells, thereby increasing bandwidth and reducing latency, among other advantages. As compared to previous carrier aggregation/multi-cell operations in which the UE is required to perform separate RACH procedures to attach to PCells and SCells, the UE may be able to perform a single RACH procedure with the vCell to connect to and communicate with all the respective serving cells of the vCell.

For the purposes of the present disclosure, and in the context of a vCell, the terms “cell,” “serving cell,” “CC,” “subband,” and similar terms, may be used interchangeably to refer to subsets of time/frequency resources of a vCell that may be aggregated, combined, bundled, or otherwise grouped together to form the vCell and to facilitate wireless communications via the vCell.

The respective serving cells of a vCell may be supported by one or more network entities. That is, the respective serving cells of a vCell may be co-located (e.g., supported by a single network entity), or non-co-located (e.g., supported by multiple, separate network entities). In some aspects, communications parameters for accessing/communicating with a given serving cell individually may be the same or different compared to communications parameters for accessing/communicating with the same serving cell as part of a vCell.

In previous wireless networks (e.g., 5G networks), UEs may be configured to select additional serving cells (e.g., SCells) based on measurements performed on reference signals received from the respective serving cells. In particular, the UE may evaluate respective serving cells on an individualized basis (e.g., cell-by-cell basis) to determine whether or not to attach to a respective cell and/or perform a handover procedure to a new cell. However, such mechanisms may not adequately support techniques for selecting vCells. That is, the evaluation of cells on an individualized basis (e.g., cell-by-cell basis) may not directly apply to selection/evaluation of vCells due to the fact that vCells include multiple serving cells, SBs, and/or CCs that are aggregated, bundled, or otherwise grouped for wireless communications (e.g., via the commo vCell identifier).

That is, in 5G wireless networks the UEs would monitor and/or measure the cell that they are camped on when they are in the RRC idle and/or inactive mode. Other cells could be either intra-frequency or inter-frequency cells. The UEs may calculate the selection criteria and compare it to indicated thresholds. If even one of the selection criteria is lower than the threshold, UE may perform neighboring cell measurements. Other cells to measure for reselection may be indicated to the UE via other system information (OSI) signaling. For example, a system information block two (SIB2) message may contain cell reselection information that is common for intra-frequency, inter-frequency and/or inter-radio access technology (RAT) cell reselection. A system information block three (SIB3) message may contain the neighboring cell related information that is relevant for intra-frequency cell reselection. The system information block four (SIB4) message may contain information relevant for inter-frequency cell reselection. Lastly, the system information block five (SIB5) message may contain information relevant for inter-RAT cell reselection.

As discussed, the vCell may provide an enhancement for carrier aggregation (CA) operations, such as within 6G wireless networks and beyond. The vCell may be considered and/or referred to as a combination of SBs, cells, and/or CCs. In some wireless networks, the CA operations may be configured to UEs after they have established a connection to the network. However, a UE could select and/or reselect to a vCell, unlike during CA operations. The vCell may reduce the latency of CA configuration.

However, (re)selection to a vCell may be associated with various issues from the perspective of the UE. One example may include the situation where there is a vCell with two SBs where the first and second SBs are intra-band and are close to each other in the frequency spectrum. In this example, a more efficient approach would be for the UE to measure one of the SBs instead of having to measure both SBs of the vCell. However, such wireless networks may not provide a mechanisms where the UE can (re)select to a vCell by only measuring one of the SBs. Another example may include the situation where there is a vCell with four SBs where the first SB is in FR1 and the other SBs are in FR2. In some cases, the SBs in the FR2 may be partially overlapping in the frequency domain. In this example the UE could only measure one or maybe two of the SBs in the FR2 simultaneously. Again, such wireless networks may not provide a mechanism for the UE to measure and/or otherwise (re)select to the vCell by only measuring some of the SBs of the vCell.

Accordingly, in such wireless networks when a UE wants to connect to any of these vCells, the UE may end up measuring every SB, cell, and/or CC of the vCell. This is because the network does not support a mechanism to indicate whether UE could perform channel measurements on a smaller set of the SBs, cells, and/or CCs of the vCell. Furthermore, if the UE is already camping on the vCell (e.g., the vCell is the serving cell of the UE), the UE would still measure every SB, cell, and/or CC of the vCell in such wireless networks. This may be due to the UE calculating the (re)selection criteria every idle discontinuous reception (IDRX) cycle. However, in the examples discussed above the UE has the potential to perform channel measurements on a limited number of SBs, cells, and/or CCs of a vCell but is unable to do so in such wireless networks. In the first example, it may be sufficient for the UE to measure only one SB instead of both SBs of the vCell. Thus, an idle or inactive mode UE would consume extra power to measure the extra SB(s). Further, in the second example an idle or inactive mode UE would be able to only observe at most two of the three FR2 SBs. It would consume extra power to measure an un-detected SB. Besides, if a UE wants to perform channel measurements on neighboring vCells to reselect to one of them, the UE would measure every SB, cell, and/or CC of the neighboring vCells. This is because as a baseline design every SB, cell, and/or CC of the neighboring vCell would be advertised rather than which SB(s), cell(s), and/or CC(s) are to be measured.

Thus, UEs may miss the opportunity to save power in such wireless networks while they are operating in an idle or inactive state and are camping on a vCell, regardless of whether the UE is measuring the vCell it is camped on or measuring neighboring vCells. One approach to resolve this issue may be that the idle or inactive mode UEs could perform channel measurements on one or a subset of the SBs, cells, or CCs of the vCell. For example, the UE may perform channel measurements on the SB, cell, or CC that UE is monitoring its paging occasion. However, this approach may result in the UE may rely on the measurements of one SB, cell, or CC of the vCell for (re)selection. This approach may be insufficient since the UE's selection criteria of other SBs, cells, and/or CCs may have changed. So, whenever the UE wants to establish a connection the UE would measure other SBs, cells, or CCs of the vCell. This may result in additional access latency. Moreover, if the camped vCell is not suitable to maintain the connection with the UE (e.g., due to degrading channel performance, UE mobility, or other causes), the UE may perform a vCell reselection before a connection establishment procedure, which may again result in increased latency.

Accordingly, aspects of the techniques described herein provide for techniques to support the network indicating to the UE which SB(s), cell(s), and/or CC(s) of the vCells that the UE is to measure while operating in the idle or inactive mode to save power on the measurements of vCells and reduce access latency. The described techniques may be equally applicable to both vCell selection and vCell reselection. In the example shown and discussed with reference to FIG. 2, the UE 205 is performing the vCell channel measurements on a neighboring cell (e.g., the vCell 215) as part of a possible cell reselection procedure. However, it is to be understood that the described techniques may be equally applicable for the vCell 210 of the UE 205 (e.g., to manage aspects of the connection between the UE 205 and its serving cell, such as the vCell 210).

For example, at 220 the vCell 210 may transmit or otherwise output (and the UE 205 may receive or otherwise obtain) a signal that identifies a measurement configuration for the UE 205. The measurement configuration may generally identify a subset of SB(s), cell(s) and/or CC(s) that are to be measured while the UE 205 is operating in an idle or inactive mode. The subset of SB(s), cell(s), and/or CC(s) that the measurement configuration identifies may be associated with a vCell, such as through a common vCell identifier. That is, in this example the measurement configuration may identify a subset (e.g., rather than all) of the SB(s), cell(s), and/or CC(s) associated with the vCell that the UE 205 is perform channel measurements on for a potential reselection procedure. At 225, the UE 205 may perform a vCell measurement procedure for the vCell (e.g., the vCell 215, in this example) while operating in the idle or inactive mode and according to the measurement configuration.

As shown, this may include the vCell 215 transmitting or otherwise outputting (and the UE 205 receiving, obtaining, or otherwise measuring) one or more reference signal(s) (RS)(s) via a wireless channel. The UE 205 may perform the channel measurements on the RS(s) transmitted from the vCell 215 to determine or otherwise obtain measurement results. At 230, the UE 205 may transmit or otherwise output (and the vCell 210 may receive or otherwise obtain) a feedback report that indicates the results of the vCell measurement procedure. In some cases, the UE 205 may transmit the feedback report to the vCell 215. In the case where the results suggest the vCell 215 would be a better serving cell of the UE 205, the feedback report may trigger a reselection procedure of the UE 205 from the vCell 210 to the vCell 215.

Thus, the signaling diagram 200 illustrates an example to help the UE 205 to maintain and/or establish a connection to vCells (e.g., the vCell 215, in this example) faster when operating in an idle or inactive state or mode. This may be based on the network (e.g., the serving cell, which is the vCell 210 in this example) indicating to the UE 205 which SB(s), cell(s), and/or CC(s) of the vCell (e.g., the subset of SB(s), cell(s), and/or CC(s)) that are to be measured when the UE 205 is operating in the idle or inactive mode for cell selection and/or for cell reselection purposes (in this example). As discussed, the indication may include the subset of SB(s), cell(s), and/or CC(s) of the vCell that the UE 205 is connected to (e.g., the vCell 210, in this example) and/or of neighboring vCells (e.g., the vCell 215, in this example).

In some cases, the vCell may indicate its own SB(s), cell(s), and/or CC(s) that are to be measured to the UE while operating in the idle or inactive mode (e.g., either via a vCell SIB1 message and/or via RRC release message). Thus, in that example the UE 205 would receive the measurement configuration from the vCell 215 rather than from the vCell 210. In some cases, the dedicated message indication to the UE 205 may override a broadcasted indication of such information (e.g., when there are differences). In some cases (such as is shown in FIG. 2), the serving vCell of the UE 205 may indicate the subset of SB(s), cell(s), and/or CC(s) of the neighboring vCells that the UE 205 is to measure while operating in the idle or inactive mode, such as via its OSI.

In some cases, the indication of the measurement configuration may be specific to a direction of communication (e.g., for which SB(s), cell(s), and/or CC(s) to measure for uplink, for downlink, or for both communication directions). In some cases, the indication of the measurement configuration may also indicate the periodicity of measurements for each indicated SB, cell, and/or CC. As one example, for a vCell with two SBs the measurement configuration may indicate that the first subband (SB1) is to be measured every IDRX cycle while the second subband (SB2) is to be measured every four IDRX cycles. Accordingly, the UE 205 may not measure every SB, cell, and/or CC of camped vCell (e.g., the serving cell) as well as neighboring vCells in the case of reselection. This may result in extensive energy savings for the UE 205. In some cases, the network may also choose the components (e.g., the SB(s), cell(s), and/or CC(s)) to be measured according to the measurement configuration according to the load on each component. Additionally, or alternatively, the network may learn which components of the vCell that UEs operating in the idle or inactive mode are to measure via statistics or artificial intelligence/machine learning (AI/ML) techniques.

Referring again to the two examples discussed above, the network may indicate via the measurement configuration which SB(s), cell(s), and/or CC(s) of the vCell that UE operating in the idle or inactive mode is to measure. However, in some scenarios the network may not know which SB(s), cell(s), and/or CC(s) of the vCell is/are better for the UE 205 to measure. In the first example (e.g., with two SBs), the UE 205 might be tuning to any of the SBs for the measurements. For instance, the network may have paging occasions (POs) on both SBs where each UE's PO depends on its UE identifier. Thus, the network may not know which UE is tuning into which SB for the channel measurements. In the second example (e.g., FR1/FR2), the network may not know which FR2 SB(s) an idle or inactive mode UE is detecting. Also, the idle or inactive mode UE may move inside the coverage area of the vCell.

Accordingly, aspects of the described techniques may include the network defining multiple vCells. In the second example discussed above, the network may define three vCells, such as one vCell for each FR2 SB. Thus, each vCell would be the FR1 SB or one of the FR2 SBs. This may include the network transmitting a SIB message for each vCell it has grouped or otherwise defined. That is, in this case the network may group some of the SB(s), cell(s), and/or CC(s) of the vCells and indicate to the UE to measure only one or a subset of the vCell(s) while operating in the idle or inactive mode. The indication may be provided to the UE 205 in an RRC release message or in a vCell SIB message. This approach may help to make the measurement indication flexible to UE operating in the idle or inactive mode while saving on the network overhead. Thus, in this approach the measurement configuration may identify the subset of SB(s), cell(s), and/or CC(s) according to a group identifier (e.g., an identifier corresponding to the grouping of the SB(s), cell(s), and/or CC(s) into vCell(s) by the network).

In some cases, the UE 205 may also learn which SB(s), cell(s), and/or CC(s) of the serving vCell and/or of the neighboring vCell(s) they could measure via statistics or AI/ML techniques (e.g., similar to the AI/ML techniques applied by the network). Additionally, or alternatively, the UE may be aware of the traffic pattern associated with wireless communications (e.g., the uplink traffic pattern at a minimum).

In some cases, the UE 205 may make suggestions to the network about their channel performance measurements of vCell(s) to be made while operating in the idle or inactive mode. For example, the UE 205 may suggest or otherwise indicate to the network which SB(s), cell(s), and/or CC(s) of the vCell(s) the UE 205 may measure while operating in the idle or inactive mode for cell (re)selection purposes. This suggestion or indication may include the vCell IDs along with their corresponding SB(s), cell(s), and/or CC(s). The network may consider the UE's suggestion when indicating the measurement indication for the vCell measurements while in the idle or inactive mode. In some cases, the UE 205 may provide the suggestion or indication to the network while it is operating in a connected mode. In some cases, the network may ask (e.g., via a request message) the UE 205 for this information before sending the RRC release message. Accordingly, in some cases the UE 205 may transmit or otherwise output (and the vCell 210 may receive or otherwise obtain) a message that identifies one or more SBs, cells, and/or CCs associated with the vCell for measurement. In this context, the one or more SBs, cells, and/or CCs are included in the subset of SB(s), cell(s), and/or CC(s) identified in the measurement configuration. That is, the network may adopt the suggestion or indication provided by the UE 205 and include the suggested or indicated SBs, cells, and/or CCs in the measurement configuration signaled to the UE 205.

In some wireless networks, a cell may advertise its neighboring intra-frequency cells via a SIB3 message and inter-frequency cells via a SIB4 message. Both of these SIB messages may carry or otherwise convey a SSB measurement and timing configuration (SMTC) for the cells being advertised. The SMTC generally indicates the timing configuration to the UEs so they can perform measurements of the neighboring cells. Both of these SIB messages also contain cell selection information. Accordingly, in such wireless networks the UE may not need to acquire the SIB1 message from the neighboring cells. However, since the vCells consist of multiple components with different carrier frequencies, this may create an issue with regard to which SIB message should the SIB1 message related information be signaled in (e.g., in the SIB3 message, in the SIB4 message, or in some other OSI/SIB message).

Accordingly, aspects of the described techniques also provide mechanisms for the network to indicate the neighboring vCell(s) information, such as via OSI signaling. For example, the signal indicating the measurement configuration may be received in a SIB2 message, in a SIB3 message, or in a SIB4 message, from a single carrier serving cell (e.g., when the vCell in this example is a non-serving cell of the UE 205). For example, a single carrier cell may advertise the neighboring vCells by including vCell-selection parameters in its SIB2 message where both SB, cell, and CC-specific and vCell-specific (re)selection parameters are provided. Additionally, or alternatively, the single carrier cell may advertise the neighboring vCells associated with intra-frequency SB(s), cell(s), and/or CC(s) information in its SIB3 message. Additionally, or alternatively, the single carrier cell may advertise the neighboring vCells associated with inter-frequency SB(s), cell(s), and/or CC(s) in its SIB4 message.

In some cases, the single carrier cell may also include information identifying to which vCell(s) these SB(s), cell(s), and/or CC(s) belong to by adding the vCell ID and/or a vCell mask. The single carrier cell may also include the type of discovery reference signal (DRS) (e.g., channel state information-reference signal (CSI-RS), tracking reference signal (TRS), or other reference signals) each component (e.g., each SB, cell, and/or CC) is communicating in. In some cases, the single frequency cell may indicate which components carry the vCell SIB1 message. In some cases, a SB, cell, and/or CC may have or otherwise be associated with multiple vCell IDs since each component may be part of more than one vCell. In this situation, the described techniques may save on network overhead. In some cases, a SB, cell, and/or CC may operate independently from a vCell. Thus, the indication for each SB, cell, and/or CC may include information identifying whether the component is operating independently or as part of a vCell.

Such techniques may generally be applicable for single-carrier cells. However, if a vCell is advertising neighboring single-carrier cells and vCells, this may create an issue regarding how such advertisements are performed using existing SIB message formats. That is, this creates an issue regarding how intra-frequency and inter-frequency are to be defined when vCells are involved. Accordingly, aspects of the described techniques may define rules to determine whether single-carrier cells and vCells, and vCells with respect to other vCells, are intra or inter-frequency. In this example, the measurement configuration may be in accordance with an intra-frequency and/or inter-frequency association between a single carrier cell and vCells or between vCells. Examples of such rules include, but not limited to, the network may choose a reference SB, cell, and/or CC for each vCell and signal this information to UEs via a SIB message. Then, the association with regards to being intra or inter-frequency may be determined with respect to the reference SB, cell, and/or CC. Another example may include defining a reference SB, cell, and/or CC as the one transmitting the SIB1 message of the vCell. Then, the association with regards to being intra or inter-frequency may be determined with respect to the reference SB, cell, and/or CC.

In some cases, if the network decides or otherwise determines to spread the vCell SIB1 message across components, then the reference SB, cell, and/or CC may be the one carrying the first piece or portion of the SIB1 message of the vCell. In some cases, the reference SB, cell, and/or CC may be the SB, cell, and/or CC that is sending the corresponding OSI (e.g., in the first SB (SB1) is being used to send the SIB3 message, then SB1 may be the reference component for intra-frequency definition). This approach may avoid the ambiguity of determining whether the vCells are either intra or inter-frequency. Then, the vCells may advertise the neighboring single-carrier and other neighboring vCells via the current framework for OSI. In some aspects, a vCell may advertise its neighboring single-carrier cells using two types of SIB messages (e.g., one for intra-frequency and one for inter-frequency).

In some aspects, the techniques described above may be applied for 6G single-carrier cells. However, a 5G cell (e.g., naturally a single carrier cell) may include vCell information in its inter-RAT SIB message (e.g., a SIB5 message). Accordingly, in some aspects the signal indicating the measurement configuration may be received in a SIB5 message from a single carrier serving cell (e.g., when the vCell is a non-serving neighboring cell). That is, 5G cells may be configured to or otherwise support extending their SIB5 message to include neighboring vCell information. The information may be the SB(s), cell(s), and/or CC(s) forming the vCell as well as any other information discussed herein. If a 6G UE (e.g., the UE 205) is camping on a 5G cell, the UE 205 may obtain the neighboring vCell information by acquiring a single SIB message (e.g., the SIB 5 message, in this example). However, if the UE is camping on a 6G single-carrier cell, the UE may acquire more than one SIB message to obtain the information about the neighboring vCells, which may cause extra energy consumption and latency for the UEs.

Accordingly, in some cases the signal indicating the measurement configuration may be provided in a SIB message that corresponds to measurement configurations for vCells. That is, this may include a new SIB message that is used for advertising neighboring vCells information. This SIB message may include any information necessary for UEs to reselect to the neighboring vCells and/or otherwise measure the vCells. The new SIB message format may include all SBs, cells, and/or CCs forming the vCell, both vCell-specific and SB, cell, and/or CC-specific parameters, and the subset of SB(s), cell(s), and/or CC(s) that the UEs are to measure for reselection while operating in the idle or inactive mode).

In some cases, the network may transmit SSBs or DRSs using the components of a vCell (e.g., the SB(s), cell(s), and/or CC(s) of the vCell) with different transmit power levels. This may impact the measurement results of the UEs. Accordingly, in some aspects the measurement configuration may carry or otherwise convey information that identifies a transmit power level for reference signals transmitted via the subset of SB(s), cell(s), and/or CC(s) during the vCell measurement procedure. That is, the network may indicate the transmit power level of reference signals in the SB(s), cell(s), and/or CC(s) of the advertised vCells in an OSI message (e.g., the signal that identifies the measurement configuration).

The indication of the transmit power level may be an absolute value, or a relative value (e.g., with respect to a reference value and/or a component of the vCell). The reference value may be (pre)defined to the UE 205 where the reference component may be indicated to the UE 205. The OSI may be either a SIB3 message, a SIB4 message, a SIB5 message, or a new SIB message format (e.g., as discussed above). Hence, this may enable the UEs to obtain more accurate results of the vCell measurement procedure while operating in the idle or inactive mode.

In some cases, the UE 205 may indicate in an early layer one (L1) report the chosen components to the network prior to connection establishment. The L1 report may be appended to a random access channel (RACH) message three (Msg3) (e.g., in a rach-msg3) or in any other uplink message before the connection establishment procedure. The report may only indicate the chosen components, in some examples. The report may include the measurements report (e.g., the results of the vCell measurement procedure), in some cases. If the network indicates to UEs which components to measure, then this may result in extra overhead for the UEs to indicate the components again just to also indicate that it has measured them. The overhead may be decreased by using existing information and predefined rules. The existing information may be the indication of the subset of SB(s), cell(s), and/or CC(s) for the UEs to measure when operating in the idle or inactive mode. The indication may be provided either in the vCell SIB message, the OSI message of other cells, or in a RRC release message.

Accordingly, aspects of the described techniques may include the feedback report being transmitted in a RACH message (e.g., a RACH message one (Msg1), a RACH Msg3, or in a RACH message A (MsgA)) during a RACH procedure. In this case, the feedback report may omit or otherwise not include the common vCell identifier or an identifier associated with the subset of SB(s), cell(s), and/or CC(s). That is, the UE 205 may report the measurement results of the indicated subset of SB(s), cell(s), and/or CC(s) without including the identifier of them in an early L1 report to the vCell during the RACH procedure to reduce signaling overhead. In some aspects, this may be based on various rules. One example of such a rule may be that the UE may report the measurement results according to the order of indication of the subset of SB(s), cell(s), and/or CC(s). For example, if a vCell has four SBs and it has indicated to the UE 205 to measure SBs 1 and 4, the UE 205 may include the measurement results of SB1 first and SB4 second.

Another example rule may be that if the network has grouped some of the SB(s), cell(s), and/or CC(s) (e.g., according to the grouping techniques discussed above), the UE 205 may include the identifier of the SB(s), cell(s), and/or CC(s) it has measured in the feedback report. In a situation where the UE 205 has performed measurements of non-configured SB(s), cell(s), and/or CC(s), the UE 205 may include these measurement results in a different list (e.g., in an “exclude list”). In the exclude list, the UE 205 may indicate the identifiers of the SB(s), cell(s), and/or CC(s) it has measured.

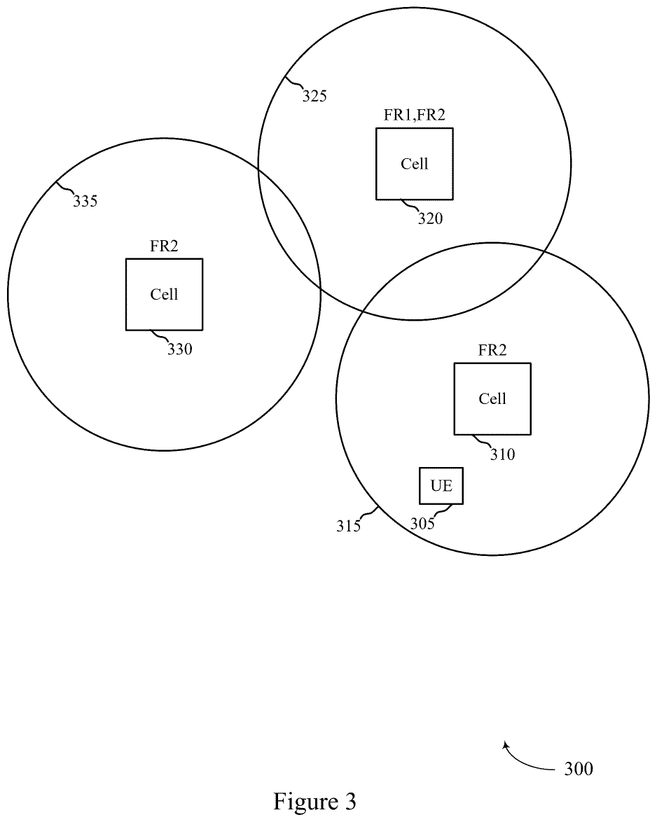

FIG. 3 shows an example of a signaling diagram 300 that supports vCell reselection measurements. Aspects of the signaling diagram 300 may be implemented at and/or may implement aspects of the wireless communication system 100 and/or aspects of the signaling diagram 200. Aspects of the signaling diagram 300 may be implemented at and/or implemented by a UE 305, a cell 310 having a corresponding coverage area 315, a cell 320 having a corresponding coverage area 325, and a cell 330 having a corresponding coverage area 335, which may be examples of the corresponding devices described herein. In some aspects, the cell 310, the cell 320, and the cell 330 may be an example of cell(s) associated with a vCell (e.g., based on a common vCell ID).

As discussed above, aspects of the techniques described herein provide for support of the network to indicate to the UE 305 which SB(s), cell(s), and/or CC(s) of the vCells that an idle or inactive mode UE (e.g., the UE 305, in this example) is to measure so the UE 305 may save power on the measurements of vCells and reduce access latency. The described techniques may be equally applicable to both vCell selection and reselection. That is, it is to be understood that the described techniques may be equally applicable for the serving vCell of the UE 305 as well as any neighboring vCells.

For example, the vCell (e.g., with the cell 310 being the serving cell of the vCell, in this example) may transmit or otherwise output (and the UE 305 may receive or otherwise obtain) a signal that identifies a measurement configuration for the UE 305. The measurement configuration may generally identify a subset of SB(s), cell(s) and/or CC(s) that are to be measured while the UE 305 is operating in an idle or inactive mode. The subset of SB(s), cell(s), and/or CC(s) that the measurement configuration may be associated with a vCell, such as through a common vCell identifier. That is, in this example, the measurement configuration may identify a subset (e.g., rather than all) of the SB(s), cell(s), and/or CC(s) associated with the vCell that the UE 305 is perform channel measurements on for a potential reselection procedure. The UE 305 may perform a vCell measurement procedure for the vCell while operating in the idle or inactive mode and according to the measurement configuration.

This may include the cell 310, the cell 320, and/or the cell 330 transmitting or otherwise outputting (and the UE 305 receiving, obtaining, or otherwise measuring) one or more reference signal(s) (RS)(s) via a wireless channel. The UE 305 may perform the channel measurements on the RS(s) transmitted from the vCell(s) (e.g., the cells in this example) to determine or otherwise obtain measurement results. The UE 305 may transmit or otherwise output (and the cell 310 may receive or otherwise obtain, in this example) a feedback report that indicates the results of the vCell measurement procedure. In the case where the results suggest the vCell would be a better serving cell of the UE 305, the feedback report may trigger a reselection procedure for the UE 305.

Thus, the signaling diagram 300 illustrates an example to help the UE 305 establish a connection to vCells faster when operating in an idle or inactive state or mode. This may be based on the network indicating to the UE 305 which SB(s), cell(s), and/or CC(s) of the vCell (e.g., the subset of SB(s), cell(s), and/or CC(s)) that are to be measured when the UE 305 is operating in the idle or inactive mode for cell selection and/or for cell reselection purposes. As discussed, the indication may include the subset of SB(s), cell(s), and/or CC(s) of the vCell that the UE 305 is connected to (e.g., the cell 310, in this example) and/or of neighboring vCells.

Signaling diagram 300 illustrates an example discussed above where there is a vCell with four SBs where a first SB (e.g., SB1) is in FR1 and the other SBs are in FR2. That is, in this example the vCell that the UE 305 is to measure consists of the cell 310 with SB(s) and/or CC(s) that are in the FR2, the cell 320 with SB(s) and/or CC(s) that are in the FR2 and in FR1, as well as the cell 330 with SB(s) and/or CC(s) that are in the FR2. This may create an issue because the network may not know which FR2 SB(s) and/or CC(s) that an idle or inactive mode UE is detecting. Moreover, the idle or inactive mode UE may move around within the vCell coverage areas (e.g., the coverage area 315, the coverage area 325, and/or the coverage area 335).

Accordingly, the UE 305 being configured with the subset of SB(s), cell(s), and/or CC(s) of the vCell formed by the cell 310, the cell 320, and the cell 330 may provide a more efficient and synchronized manner in which the UE 305 is to perform the vCell measurement procedure. This approach may ensure that the UE 305 and the network are synchronized with respect to which SB or CC is performing the reference signal transmissions during the measurement procedure. In some cases, the network may redefine or otherwise group some of the SB(s), cell(s), and/or CC(s) into individual vCells for further improved synchronization and alignment.

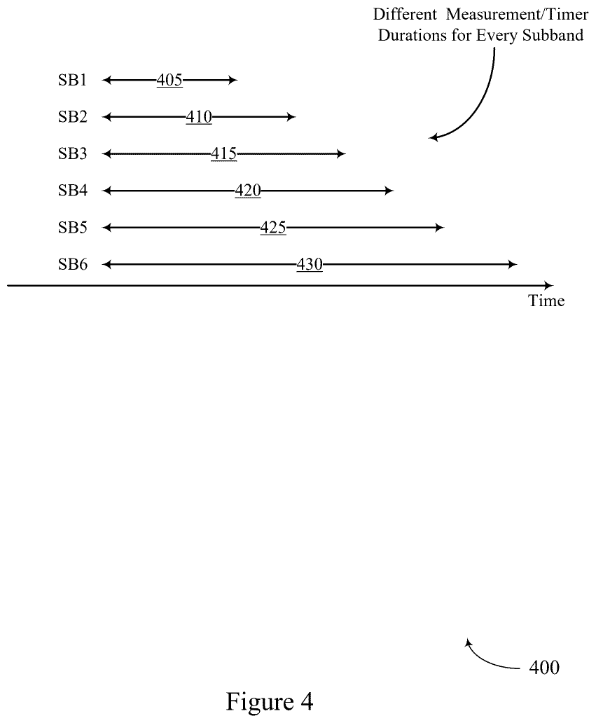

FIG. 4 shows an example of a timing diagram 400 that supports vCell reselection measurements. Aspects of the timing diagram 400 may be implemented at and/or may implement aspects of the wireless communication system 100, aspects of the signaling diagram 200, and/or aspects of the signaling diagram 300. Aspects of the timing diagram 400 may be implemented at and/or implemented by a UE and a network entity (e.g., a vCell), which may be examples of the corresponding devices described herein. In some aspects, the vCell may be associated with a subset of SB(s), cell(s), and/or CC(s) based on a common vCell ID.

As discussed above, aspects of the techniques described herein provide for support of the network to indicate to the UE which SB(s), cell(s), and/or CC(s) of the vCells that an idle or inactive mode UE is to measure so the UE may save power on the measurements of vCells and reduce access latency. The described techniques may be equally applicable to both vCell selection and reselection. That is, it is to be understood that the described techniques may be equally applicable for the serving vCell of the UE as well as any neighboring vCells.

For example, the vCell may transmit or otherwise output (and the UE may receive or otherwise obtain) a signal that identifies a measurement configuration for the UE. The measurement configuration may generally identify a subset of SB(s), cell(s) and/or CC(s) that are to be measured while the UE 305 is operating in an idle or inactive mode. The subset of SB(s), cell(s), and/or CC(s) that the measurement configuration identifies may be associated with a vCell, such as through a common vCell identifier. That is, in this example the measurement configuration may identify a subset (e.g., rather than all) of the SB(s), cell(s), and/or CC(s) associated with the vCell that the UE is to perform channel measurements on for a potential reselection procedure. The UE may perform a vCell measurement procedure for the vCell while operating in the idle or inactive mode and according to the measurement configuration.

This may include the vCell transmitting or otherwise outputting (and the UE receiving, obtaining, or otherwise measuring) one or more reference signal(s) (RS)(s) via a wireless channel. The UE may perform the channel measurements on the RS(s) transmitted from the vCell(s) (e.g., the cells of the vCell, in this example) to determine or otherwise obtain measurement results. The UE may transmit or otherwise output (and the vCell may receive or otherwise obtain) a feedback report that indicates the results of the vCell measurement procedure. In the case where the results suggest the vCell would be a better serving cell of the UE, the feedback report may trigger a reselection procedure for the UE.

In some wireless networks, UEs may be configured to perform cell measurements while they have entered the idle or inactive state or mode. The UEs may be indicated or otherwise configured with which cells are to be measured. The indication may be signaled via a system information block eleven (SIB11) message or in an RRC release message. The SIB11 message may contain a MeasIdleConfigSIB information element (IE) and the RRCrelease message may contain a MeasIdleConfigDedicated IE. When the UE is configured with idle measurements (either through SIB11 or RRCrelease message), the UE would start measuring the indicated cells.

In some aspects, the duration of such measurements may be indicated to the UEs. As one example, the indication of the measurement duration may be used by the UE to set a T331 timer. Generally, the idle or inactive mode UE would continue performing the measurements until either the T331 time expires or the UE (re)selects a cell out of a valid list of cells (or another RAT).

However, in some aspects there may be a vCell with five SBs where SBs 1and 2 are intra-band and SBs 3, 4, and 5 are intra-band (e.g., the two groups of SBs are inter-band). Thus, the network may indicate to UEs to measure two SBs instead of all 5(e.g., one SB from each group), such as in the measurement configuration. In some cases, there may be a UE that is connected to the vCell which usually requires the UE to use all five SBs because of a high data traffic pattern. Accordingly, the network may configure this specific UE with idle measurements when releasing it so the UE would measure all the SBs. However, if the current framework for idle measurements is used then the UE would measure every SB until the T331 expires.

Thus, aspects of the described techniques may support measurement durations that are different for different SBs. That is, the measurement configuration may identify a measurement duration (e.g., the T331 timer durations) for each SB, cell, and/or CC in the subset of SB(s), cell(s), and/or CC(s) such that the measurement duration is different for each SB, cell, and/or CC. For example, sometimes it may not be helpful for the idle or inactive mode UE to perform intense measurements of every SB of the vCell. For example, whenever there is no data, the upper layer (e.g., transport layer) may decrease the dedicated data rate, instead of just removing it. If UEs do not measure most of the SBs of the vCell beforehand, they might not be able to match the data rate established by the upper layer. Also, if the UE measures the vCell intensely, this might consume extra power in an unnecessary manner.

Accordingly, aspects of the described techniques may include the network indicating different idle measurement durations (e.g., values of T331) for each SB, cell, and/or CC (which may be band-specific and/or FR-specific) of a vCell. This approach may be equally applicable to both the serving vCell of the UE as well as neighboring vCells too. As shown in timing diagram 400, this may include a vCell with six SBs. In this example, the first subband 405 may be configured with a first measurement duration, the second subband 410 may be configured with a second measurement duration, the third subband 415 may be configured with a third measurement duration, the fourth subband 420 may be configured with a fourth measurement duration, the fifth subband 425 may be configured with a fifth measurement duration, and the sixth subband 430 may be configured with a sixth measurement duration. As shown, the measurement duration of each subband is a different time duration in the time domain. Of course, in some examples not every SB, cell, and/or CC of the vCell may have a different measurement duration indicated to the UE.

This approach may help to enable the SB, cell, and/or CC-specific T331 timers so the UEs could benefit from the high bandwidth of the vCell while not consuming additional power. This approach may be applicable for idle measurement purposes as well as for vCell selection and reselection purposes.

In some wireless networks, when UEs are operating in the inactive mode, the UEs may submit their idle or inactive mode measurement reports to the network. Such mechanisms may be applied in accordance with vCells. When the UE is submitting its idle or inactive mode measurement reports to the network (e.g., while operating in the inactive mode or in the connected mode), the UE may have measurements of non-configured components (e.g., non-configured SB(s), cell(s), and/or CC(s), such as due to the UE's algorithm.

Accordingly, aspects of the described techniques may provide for the feedback report to indicate a measurement result of one or more non-configured SB(s), cell(s), and/or CC(s) of the vCell or of a different vCell. That is, the UE may indicate to the network that they have measurements of non-configured SB(s), cell(s), and/or CC(s) of vCell(s). If the network allows such reporting, the UE may submit the report of the non-configured SB(s), cell(s), and/or CC(s) of vCell(s).

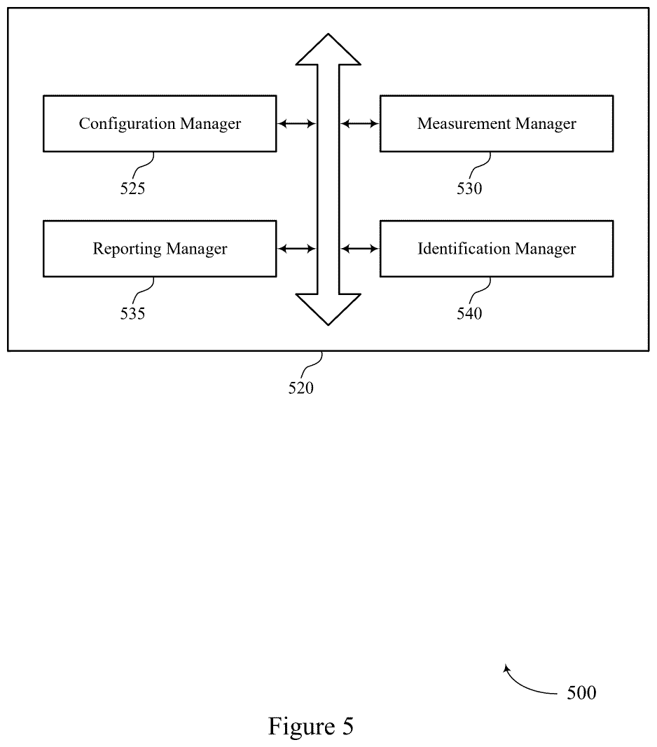

FIG. 5 shows an example 500 of a processing system 520 that supports vCell reselection measurements. A processing system 520 may be an example of a processing system 140 (such as of a UE 115) and may include a configuration manager 525, a measurement manager 530, a reporting manager 535, an identification manager 540, or any combination thereof. A processing system 520, or various component thereof, may be an example of means for performing (such as a means for causing a UE 115 to perform) various techniques described herein.

The configuration manager 525 may be configured to cause the UE 115 to receive a signal that identifies a measurement configuration for the UE, the measurement configuration identifying a subset of subbands, cells, or CCs that are to be measured while the UE is operating in an idle or inactive mode, where the subset of subbands, cells, or CCs are associated with a vCell through a common vCell identifier. The measurement manager 530 may be configured to cause the UE 115 to perform a vCell measurement procedure for the vCell while operating in the idle or inactive mode according to the measurement configuration. The reporting manager 535 may be configured to cause the UE 115 to transmit a feedback report that indicates a result of the vCell measurement procedure. In some examples, the measurement configuration identifies the subset of subbands, cells, or CCs according to a group identifier.

In some examples, the identification manager 540 may be configured to cause the UE 115 to transmit a message that identifies one or more subbands, cells, or CCs associated with the vCell for measurement, where the one or more subbands, cells, or CCs are included in the subset of subbands, cells, or CCs identified in the signal based on the one or more subbands, cells, or CCs being included in the message. In some examples, the signal is received in a SIB2 message, in a SIB3 message, or in a SIB4 message from a single carrier serving cell and the vCell includes a non-serving neighboring cell. In some examples, the measurement configuration is in accordance with an intra-frequency or an inter-frequency association between a single carrier cell and vCells or between vCells.

In some examples, the signal is received in a SIB5 message from a single carrier serving cell and the vCell includes a non-serving neighboring cell. In some examples, the signal is received in an SIB message that corresponds to measurement configurations for vCells. In some examples, the measurement configuration identifies a transmit power level for reference signals transmitted via the subset of subbands, cells, or CCs during the vCell measurement procedure. In some examples, the feedback report is transmitted in a RACH message during a RACH procedure and omits the common vCell identifier or an identifier associated with the subset of subbands, cells, or CCs. In some examples, the measurement configuration identifies a measurement duration for each subband, cell, or CC in the subset of subbands, cells, or CCs. In some examples, the measurement duration is different for each subband, cell, or CC. In some examples, the feedback report includes measurement results for one or more non-configured subbands, cells, or CCs of the vCell or of a different vCell.

A processing system 520 may include or be a component of one or more chips, systems-on-chips (SoCs), chipsets, packages, components, or devices that individually or collectively constitute or include a processing system. A processing system 520 may interface with other components of a processing system 520. For example, operations described with reference to a processing system 520, or various components thereof, may be performed by or with other such components, including a receiver, a transmitter, a transceiver, a modem, a user interface, a modulator/demodulator, an encoder/decoder, or any combination thereof (such as of the processing system 520, coupled (e.g., directly, indirectly, without pre-processing, after pre-processing) with the processing system 520, of a processing system 520).

By including or configuring a processing system 520 for operation in a processing system 520 as described herein, the processing system 520 may support techniques for configuring a subset of SB(s), cell(s), and/or CC(s) of a vCell for channel measurements by a UE. This approach may conserve UE power as well as reduce the latency associated with UE mobility.

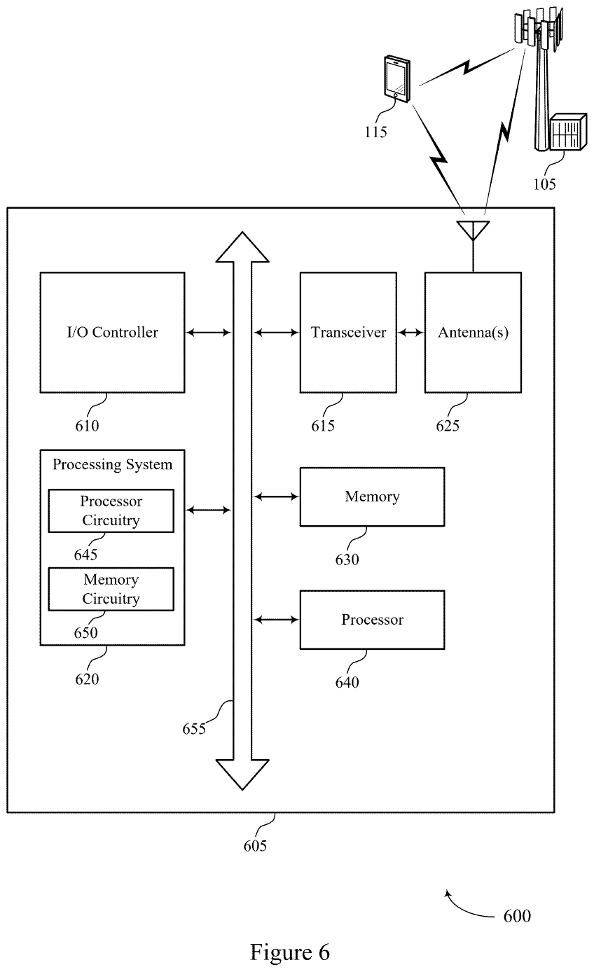

FIG. 6 shows an example of a system 600 including a device 605 that supports vCell reselection measurements. The device 605 may be an example of or include components of UE 115. The device 605 may communicate (such as wirelessly) with one or more other devices (such as network entities 105, UEs 115). The device 605 may include components for transmitting and receiving communication, which may include a processing system 620, an input/output (I/O) controller, such as an I/O controller 610, a transceiver 615, antenna(s) 625, a memory 630, and a processor 640. Components of the device 605 may be coupled (such as operatively, communicatively, functionally, electronically, electrically, in electronic communication) a bus 655.

The transceiver 615 may support bi-directional communication via antenna(s) 625, and may support transmission operations, reception operations, or both, as described herein. The transceiver 615 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 605). The transceiver 615 may modulate symbols and provide the modulated symbols to antenna(s) 625 for transmission, and demodulate symbols from signals received using antenna(s) 625.

The processor 640 may be a general-purpose processing component that supports various operations (such as applications) of the device 605. The memory 630 may be a general-purpose storage component that stores code executable by the processor 640. Such code may include instructions that, when executed by the processor 640, cause the device 605 to perform various functions (such as to support an application of the device 605). The I/O controller 610 may manage inputs and outputs for the device 605, may manage peripherals not integrated into the device 605, or may represent a physical connection (such as port) to an external peripheral. The processor 640 may interact with a modem, a keyboard, a mouse, a touchscreen, or other device (such as via I/O controller 610). In some implementations, a user may interact with the device 605 via the I/O controller 610 or via hardware components controlled by the I/O controller 610.

The processing system 620 may be an example of a processing system 140 or a processing system 520. For example, the processing system 620 may include processor circuitry 645 and memory circuitry 650 that stores code, and may be configured to cause the device 605 to perform operations that support vCell reselection measurements. Although the processing system 620 is illustrated as a separate component, which may involve a separate chip, chipset, or other module, in some implementations, one or more functions described with reference to the processing system 620 may be supported by or performed by a transceiver 615, antenna(s) 625, a processor 640, memory 630, or any combination thereof, such that a processing system 620 may include one or more of a transceiver 615, antenna(s) 625, a processor 640, memory 630, or any combination thereof.

By including or configuring the processing system 620 for operation in the device 605 as described herein, may support techniques for configuring a subset of SB(s), cell(s), and/or CC(s) of a vCell for channel measurements by a UE. This approach may conserve UE power as well as reduce the latency associated with UE mobility.

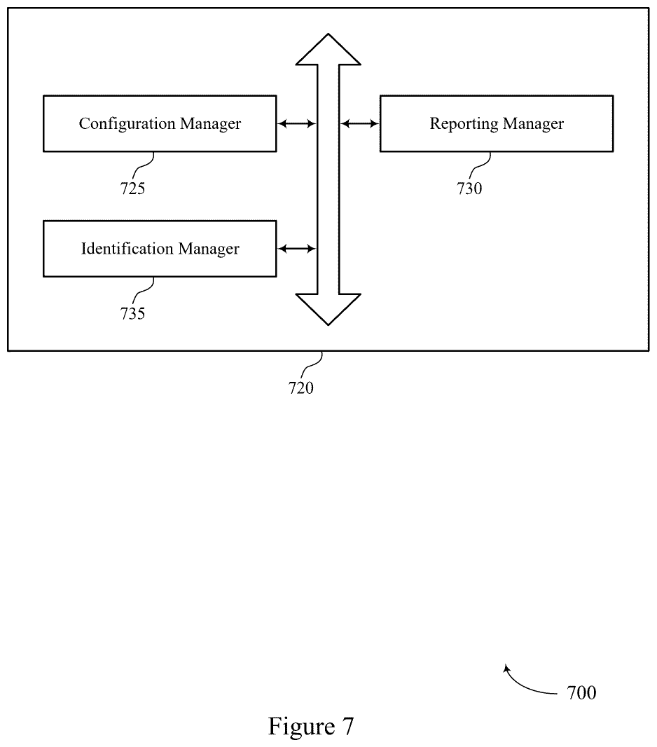

FIG. 7 shows an example 700 of a processing system 720 that supports vCell reselection measurements. A processing system 720 may be an example of a processing system 145 (such as network entity 105) and may include a configuration manager 725, a reporting manager 730, an identification manager 735, or any combination thereof. A processing system 720, or various component thereof, may be an example of means for performing (such as a means for causing a network entity 105 to perform) various techniques described herein.

The configuration manager 725 may be configured to cause the network entity 105 to transmit, to a UE, a signal that identifies a measurement configuration for the UE, the measurement configuration identifying a subset of subbands, cells, or CCs that are to be measured while the UE is operating in an idle or inactive mode, where the subset of subbands, cells, or CCs are associated with a vCell through a common vCell identifier. The reporting manager 730 may be configured to cause the network entity 105 to receive, from the UE, a feedback report that indicates a result of a vCell measurement procedure performed for the vCell while the UE operates in the idle or inactive mode according to the measurement configuration. In some examples, the measurement configuration identifies the subset of subbands, cells, or CCs according to a group identifier.

In some examples, the identification manager 735 may be configured to cause the network entity 105 to receive, from the UE, a message that identifies one or more subbands, cells, or CCs associated with the vCell for measurement, where the one or more subbands, cells, or CCs are included in the subset of subbands, cells, or CCs identified in the signal based on the one or more subbands, cells, or CCs being included in the message.

In some examples, the signal is transmitted in a SIB2 message, in a SIB3 message, or in a SIB4 message from a single carrier serving cell and the vCell includes a non-serving neighboring cell. In some examples, the measurement configuration is in accordance with an intra-frequency or an inter-frequency association between a single carrier cell and vCells or between vCells. In some examples, the signal is transmitted in a SIB5 message from a single carrier serving cell and the vCell includes a non-serving neighboring cell. In some examples, the signal is transmitted in an SIB message that corresponds to measurement configurations for vCells.

In some examples, the measurement configuration identifies a transmit power level for reference signals transmitted via the subset of subbands, cells, or CCs during the vCell measurement procedure. In some examples, the feedback report is received in a RACH message during a RACH procedure and omits the common vCell identifier or an identifier associated with the subset of subbands, cells, or CCs. In some examples, the measurement configuration identifies a measurement duration for each subband, cell, or CC in the subset of subbands, cells, or CCs. In some examples, the measurement duration is different for each subband, cell, or CC. In some examples, the feedback report includes measurement results for one or more non-configured subbands, cells, or CCs of the vCell or of a different vCell.

A processing system 720 may include or be an example of one or more chips, SoCs, chipsets, packages, components, or devices that individually or collectively constitute or include a processing system. A processing system 720 may interface with other components of a network entity 105. For example, operations described with reference to a processing system 720, or various components thereof, may be performed by or with other such components, including a receiver, a transmitter, a transceiver, a modem, a user interface, a modulator/demodulator, an encoder/decoder, or any combination thereof (such as of the processing system 720, coupled with the processing system 720, of a network entity 105). Operations described herein with reference to the processing system 720, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 720 for operation in a processing system 720 as described herein, the processing system 720 may support techniques for configuring a subset of SB(s), cell(s), and/or CC(s) of a vCell for channel measurements by a UE. This approach may conserve UE power as well as reduce the latency associated with UE mobility.

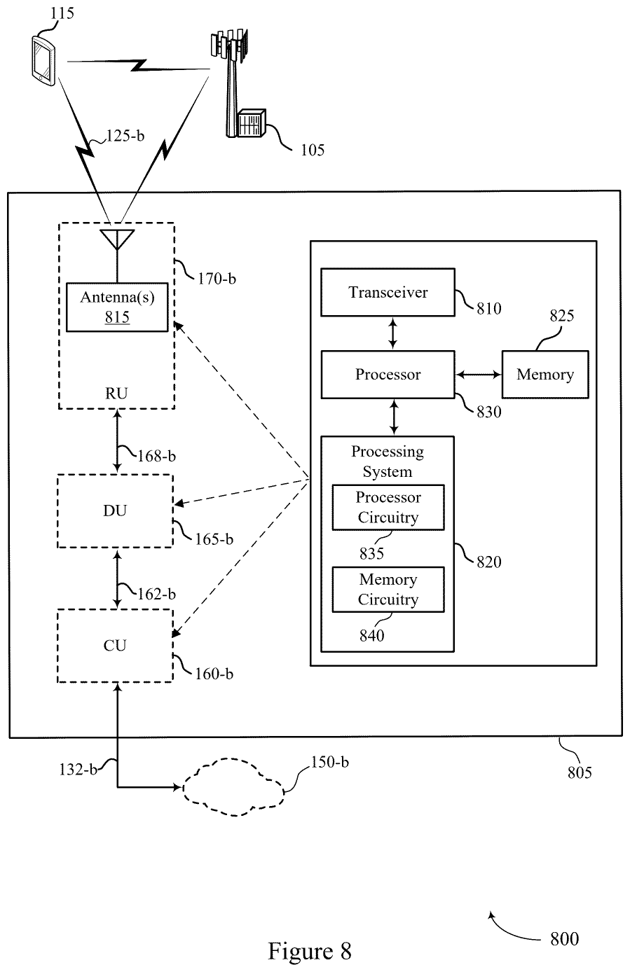

FIG. 8 shows an example of a system 800 including a device 805 that supports vCell reselection measurements. The device 805 may communicate (such as via one or more wired interfaces or one or more wireless interfaces) with other network devices or network equipment such as a core network 150-b, other network entities 105, UEs 115, or any combination thereof. The device 805 may include components for transmitting and receiving communication, which may include a processing system 820, a transceiver 810, antenna(s) 815, a memory 825, and a processor 830. Components of the device 805 may be coupled (such as operatively, communicatively, functionally, electronically, electrically, in electronic communication) via one or more interfaces.

The transceiver 810 may communicate bi-directionally with another transceiver via wired or wireless links, and may support transmission operations, reception operations, or both, as described herein. The transceiver 810 may include a modem to modulate and demodulate signals, to provide the modulated signals for transmission (such as via antenna(s) 815, via a wired interface), and to demodulate received signals (such as received via antenna(s) 815, received via a wired interface). The transceiver 810 may be operable to support communication via one or more communication links (such as a communication link 125-b, a backhaul link 132-b, a midhaul link 162-b, fronthaul link 168-b).

The processor 830 may be a general-purpose processing component that supports various operations (such as applications) of the device 805. The memory 825 may be a general-purpose storage component that stores code executable by the processor 830. Such code may include instructions that, when executed by the processor 830, cause the device 805 to perform various functions (such as to support an application of the device 805).

For examples in which the device 805 is a network entity 105 in a disaggregated architecture, one or more components of the device 805 may be located at one or more of a CU 160-b, a DU 165-b, or an RU 170-b, one or more of which may include aspects of the processing system 820, the processor 830, the memory 825, or the transceiver 810. Functions of the device 805 may be performed at different components or an operation may be divided between different components (such as different functions being supported by aspects of the CU 160-b, the DU 165-b, or the RU 170-b, the transceiver 810, the processor 830, the memory 825, the processing system 820, or any combination thereof). For example, the processing system 820 may be a component of one or more of the CU 160-b, the DU 165-b, or the RU 170-b. In some examples, interfaces between components of device 805 (such as CU 160-b, DU 165-b, RU 170-b) may support communication at a protocol layer or between protocol layers of a protocol stack.

In some examples, the processing system 820 may manage aspects of communication with the core network 150-b (such as via a backhaul link 132). For example, the processing system 820 may manage the transfer of data communication for UEs 115 with a gateway of the core network 150-b. In some examples, the processing system 820 may manage communication with one or more other network entities 105 and may include a controller or scheduler for controlling communication with UEs 115 (such as in cooperation with the one or more other network entities 105). In some examples, the processing system 820 may support an interface (such as X2 interface, Xn interface) to provide communication between network entities 105.

The processing system 820 may be an example of a processing system 145 or a processing system 720. For example, the processing system 820 may include processor circuitry 835 and memory circuitry 840 that stores code, and the processing system 820 may be configured to cause the device 805 to perform operations that support vCell reselection measurements. Although the processing system 820 is illustrated as a separate component, which may involve a separate chip, chipset, or other module, in some implementations, one or more functions described with reference to the processing system 820 may be supported by or performed by a transceiver 810, antenna(s) 815, a processor 830, memory 825, or any combination thereof, such that a processing system 820 may include one or more of a transceiver 810, antenna(s) 815, a processor 830, memory 825, or any combination thereof. Further, processor circuitry 835 and memory circuitry 840 each may be implemented at the device 805 in accordance with an aggregated architecture, or the processor circuitry 835 and the memory circuitry 840 may be implemented at one or more of a CU 160-b, a DU 165-b, or an RU 170-b in accordance with a disaggregated architecture.

By including or configuring the processing system 820 for operation in the device 805 as described herein, may support techniques for configuring a subset of SB(s), cell(s), and/or CC(s) of a vCell for channel measurements by a UE. This approach may conserve UE power as well as reduce the latency associated with UE mobility.

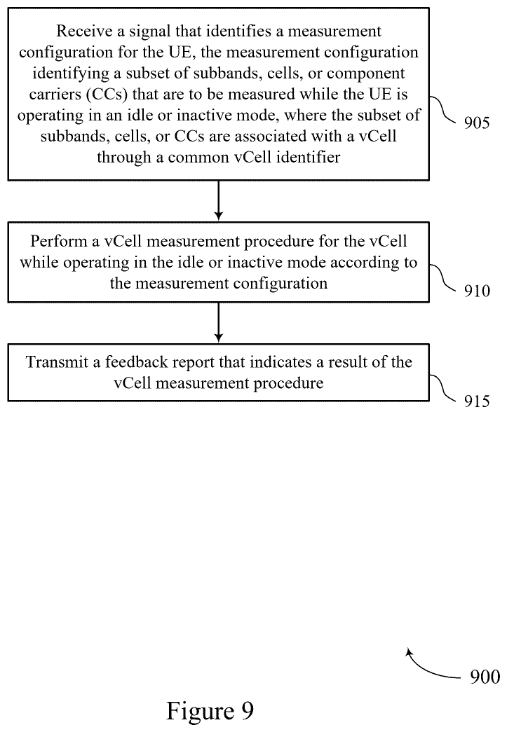

FIG. 9 shows an example of a method 900 that supports vCell reselection measurements. Operations of the method 900 may be performed by a UE or its components (such as using a processing system configured to cause the UE 115 to perform one or more of the operations) as described herein.

At 905, the method may include receiving a signal that identifies a measurement configuration for the UE, the measurement configuration identifying a subset of subbands, cells, or CCs that are to be measured while the UE is operating in an idle or inactive mode, where the subset of subbands, cells, or CCs are associated with a vCell through a common vCell identifier. In some examples, aspects of the operations of 905 may be performed by a configuration manager 525.

At 910, the method may include performing a vCell measurement procedure for the vCell while operating in the idle or inactive mode according to the measurement configuration. In some examples, aspects of the operations of 910 may be performed by a measurement manager 530.

At 915, the method may include transmitting a feedback report that indicates a result of the vCell measurement procedure. In some examples, aspects of the operations of 915 may be performed by a reporting manager 535.

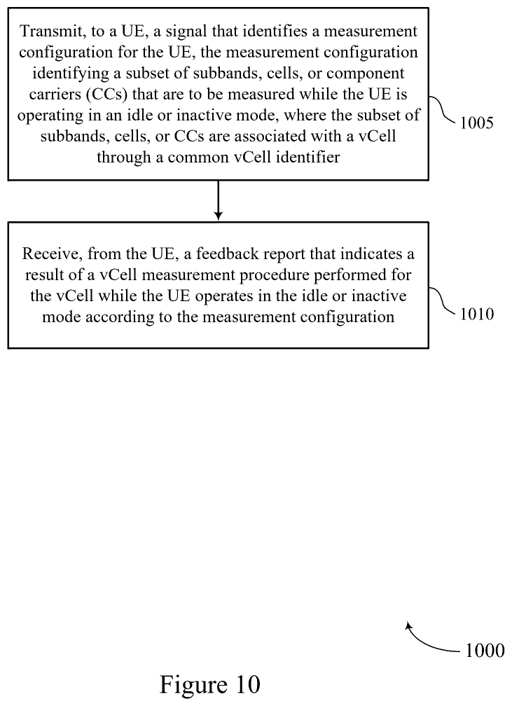

FIG. 10 shows an example of a method 1000 that supports vCell reselection measurements. Operations of the method 1000 may be performed by a network entity 105 or its components (such as using a processing system configured to cause the network entity to perform one or more operations) as described herein.

At 1005, the method may include transmitting, to a UE, a signal that identifies a measurement configuration for the UE, the measurement configuration identifying a subset of subbands, cells, or CCs that are to be measured while the UE is operating in an idle or inactive mode, where the subset of subbands, cells, or CCs are associated with a vCell through a common vCell identifier. In some examples, aspects of the operations of 1005 may be performed by a configuration manager 725.

At 1010, the method may include receiving, from the UE, a feedback report that indicates a result of a vCell measurement procedure performed for the vCell while the UE operates in the idle or inactive mode according to the measurement configuration. In some examples, aspects of the operations of 1010 may be performed by a reporting manager 730.

Implementation examples are described in the following numbered clauses:
Aspect 1: A method for wireless communications at a UE, comprising: receiving a signal that identifies a measurement configuration for the UE, the measurement configuration identifying a subset of subbands, cells, or CCs that are to be measured while the UE is operating in an idle or inactive mode, wherein the subset of subbands, cells, or CCs are associated with a vCell through a common vCell identifier; performing a vCell measurement procedure for the vCell while operating in the idle or inactive mode according to the measurement configuration; and transmitting a feedback report that indicates a result of the vCell measurement procedure.
Aspect 2: The method of aspect 1, wherein the measurement configuration identifies the subset of subbands, cells, or CCs according to a group identifier.
Aspect 3: The method of any of aspects 1 through 2, further comprising: transmitting a message that identifies one or more subbands, cells, or CCs associated with the vCell for measurement, wherein the one or more subbands, cells, or CCs are included in the subset of subbands, cells, or CCs identified in the signal based at least in part on the one or more subbands, cells, or CCs being included in the message.
Aspect 4: The method of any of aspects 1 through 3, wherein the signal is received in a SIB2 message, in a SIB3 message, or in a SIB4 message from a single carrier serving cell and the vCell comprises a non-serving neighboring cell.
Aspect 5: The method of any of aspects 1 through 4, wherein the measurement configuration is in accordance with an intra-frequency or an inter-frequency association between a single carrier cell and vCells or between vCells.
Aspect 6: The method of any of aspects 1 through 5, wherein the signal is received in a SIB5 message from a single carrier serving cell and the vCell comprises a non-serving neighboring cell.
Aspect 7: The method of any of aspects 1 through 6, wherein the signal is received in an SIB message that corresponds to measurement configurations for vCells.
Aspect 8: The method of any of aspects 1 through 7, wherein the measurement configuration identifies a transmit power level for reference signals transmitted via the subset of subbands, cells, or CCs during the vCell measurement procedure.
Aspect 9: The method of any of aspects 1 through 8, wherein the feedback report is transmitted in a RACH message during a RACH procedure and omits the common vCell identifier or an identifier associated with the subset of subbands, cells, or CCs.
Aspect 10: The method of any of aspects 1 through 9, wherein the measurement configuration identifies a measurement duration for each subband, cell, or CC in the subset of subbands, cells, or CCs, and the measurement duration is different for each subband, cell, or CC.
Aspect 11: The method of any of aspects 1 through 10, wherein the feedback report comprises measurement results for one or more non-configured subbands, cells, or CCs of the vCell or of a different vCell.
Aspect 12: A method for wireless communications at a network entity, comprising: transmitting, to a UE, a signal that identifies a measurement configuration for the UE, the measurement configuration identifying a subset of subbands, cells, or CCs that are to be measured while the UE is operating in an idle or inactive mode, wherein the subset of subbands, cells, or CCs are associated with a vCell through a common vCell identifier; and receiving, from the UE, a feedback report that indicates a result of a vCell measurement procedure performed for the vCell while the UE operates in the idle or inactive mode according to the measurement configuration.
Aspect 13: The method of aspect 12, wherein the measurement configuration identifies the subset of subbands, cells, or CCs according to a group identifier.
Aspect 14: The method of any of aspects 12 through 13, further comprising: receiving, from the UE, a message that identifies one or more subbands, cells, or CCs associated with the vCell for measurement, wherein the one or more subbands, cells, or CCs are included in the subset of subbands, cells, or CCs identified in the signal based at least in part on the one or more subbands, cells, or CCs being included in the message.
Aspect 15: The method of any of aspects 12 through 14, wherein the signal is transmitted in a SIB2 message, in a SIB3 message, or in a SIB4 message from a single carrier serving cell and the vCell comprises a non-serving neighboring cell.
Aspect 16: The method of any of aspects 12 through 15, wherein the measurement configuration is in accordance with an intra-frequency or an inter-frequency association between a single carrier cell and vCells or between vCells.
Aspect 17: The method of any of aspects 12 through 16, wherein the signal is transmitted in a SIB5 message from a single carrier serving cell and the vCell comprises a non-serving neighboring cell.
Aspect 18: The method of any of aspects 12 through 17, wherein the signal is transmitted in an SIB message that corresponds to measurement configurations for vCells.
Aspect 19: The method of any of aspects 12 through 18, wherein the measurement configuration identifies a transmit power level for reference signals transmitted via the subset of subbands, cells, or CCs during the vCell measurement procedure.
Aspect 20: The method of any of aspects 12 through 19, wherein the feedback report is received in a RACH message during a RACH procedure and omits the common vCell identifier or an identifier associated with the subset of subbands, cells, or CCs.
Aspect 21: The method of any of aspects 12 through 20, wherein the measurement configuration identifies a measurement duration for each subband, cell, or CC in the subset of subbands, cells, or CCs, and the measurement duration is different for each subband, cell, or CC.
Aspect 22: The method of any of aspects 12 through 21, wherein the feedback report comprises measurement results for one or more non-configured subbands, cells, or CCs of the vCell or of a different vCell.
Aspect 23: A UE for wireless communications, comprising one or more memories that store processor-executable code and one or more processors coupled with the one or more memories that are individually or collectively operable to execute the code to cause the UE to perform a method of any of aspects 1 through 11.
Aspect 24: A UE for wireless communications, comprising at least one means for performing a method of any of aspects 1 through 11.
Aspect 25: A non-transitory computer-readable medium storing code for wireless communications, the code comprising instructions executable by one or more processors to perform a method of any of aspects 1 through 11.
Aspect 26: A network entity for wireless communications, comprising one or more memories that store processor-executable code and one or more processors coupled with the one or more memories that are individually or collectively operable to execute the code to cause the network entity to perform a method of any of aspects 12 through 22.
Aspect 27: A network entity for wireless communications, comprising at least one means for performing a method of any of aspects 12 through 22.
Aspect 28: A non-transitory computer-readable medium storing code for wireless communications, the code comprising instructions executable by one or more processors to perform a method of any of aspects 12 through 22.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a signal that identifies a measurement configuration for the UE, the measurement configuration identifying a subset of subbands, cells, or component carriers (CCs) that are to be measured while the UE is operating in an idle or inactive mode, wherein the subset of subbands, cells, or CCs are associated with a virtual cell through a common virtual cell identifier;
perform a virtual cell measurement procedure for the virtual cell while operating in the idle or inactive mode according to the measurement configuration; and
transmit a feedback report that indicates a result of the virtual cell measurement procedure.

2. The UE of claim 1, wherein the measurement configuration identifies the subset of subbands, cells, or CCs according to a group identifier.

3. The UE of claim 1, wherein the one or more processors are individually or collectively further operable to execute the code to cause the UE to:
transmit a message that identifies one or more subbands, cells, or CCs associated with the virtual cell for measurement, wherein the one or more subbands, cells, or CCs are included in the subset of subbands, cells, or CCs identified in the signal based at least in part on the one or more subbands, cells, or CCs being included in the message.

4. The UE of claim 1, wherein the signal is received in a system information block two (SIB2) message, in a system information block three (SIB3) message, or in a system information block four (SIB4) message from a single carrier serving cell and the virtual cell comprises a non-serving neighboring cell.

5. The UE of claim 1, wherein the measurement configuration is in accordance with an intra-frequency or an inter-frequency association between a single carrier cell and virtual cells or between virtual cells.

6. The UE of claim 1, wherein the signal is received in a system information block five (SIB5) message from a single carrier serving cell and the virtual cell comprises a non-serving neighboring cell.

7. The UE of claim 1, wherein the signal is received in a system information block (SIB) message that corresponds to measurement configurations for virtual cells.

8. The UE of claim 1, wherein the measurement configuration identifies a transmit power level for reference signals transmitted via the subset of subbands, cells, or CCs during the virtual cell measurement procedure.

9. The UE of claim 1, wherein the feedback report is transmitted in a random access channel (RACH) message during a RACH procedure and omits the common virtual cell identifier or an identifier associated with the subset of subbands, cells, or CCs.

10. The UE of claim 1, wherein:
the measurement configuration identifies a measurement duration for each subband, cell, or CC in the subset of subbands, cells, or CCs, and
the measurement duration is different for each subband, cell, or CC.

11. The UE of claim 1, wherein the feedback report comprises measurement results for one or more non-configured subbands, cells, or CCs of the virtual cell or of a different virtual cell.

12. A network entity, comprising:
one or more memories storing processor-executable code; and
one or more processors coupled with the one or more memories and individually or collectively operable to execute the code to cause the network entity to:
transmit, to a user equipment (UE), a signal that identifies a measurement configuration for the UE, the measurement configuration identifying a subset of subbands, cells, or component carriers (CCs) that are to be measured while the UE is operating in an idle or inactive mode, wherein the subset of subbands, cells, or CCs are associated with a virtual cell through a common virtual cell identifier; and
receive, from the UE, a feedback report that indicates a result of a virtual cell measurement procedure performed for the virtual cell while the UE operates in the idle or inactive mode according to the measurement configuration.

13. The network entity of claim 12, wherein the measurement configuration identifies the subset of subbands, cells, or CCs according to a group identifier.

14. The network entity of claim 12, wherein the one or more processors are individually or collectively further operable to execute the code to cause the network entity to:
receive, from the UE, a message that identifies one or more subbands, cells, or CCs associated with the virtual cell for measurement, wherein the one or more subbands, cells, or CCs are included in the subset of subbands, cells, or CCs identified in the signal based at least in part on the one or more subbands, cells, or CCs being included in the message.

15. The network entity of claim 12, wherein the signal is transmitted in a system information block two (SIB2) message, in a system information block three (SIB3) message, or in a system information block four (SIB4) message from a single carrier serving cell and the virtual cell comprises a non-serving neighboring cell.

16. The network entity of claim 12, wherein the measurement configuration is in accordance with an intra-frequency or an inter-frequency association between a single carrier cell and virtual cells or between virtual cells.

17. The network entity of claim 12, wherein the signal is transmitted in a system information block five (SIB5) message from a single carrier serving cell and the virtual cell comprises a non-serving neighboring cell.

18. The network entity of claim 12, wherein the signal is transmitted in a system information block (SIB) message that corresponds to measurement configurations for virtual cells.

19. The network entity of claim 12, wherein the measurement configuration identifies a transmit power level for reference signals transmitted via the subset of subbands, cells, or CCs during the virtual cell measurement procedure.

20. A method for wireless communications at a user equipment (UE), comprising:
receiving a signal that identifies a measurement configuration for the UE, the measurement configuration identifying a subset of subbands, cells, or component carriers (CCs) that are to be measured while the UE is operating in an idle or inactive mode, wherein the subset of subbands, cells, or CCs are associated with a virtual cell through a common virtual cell identifier;
performing a virtual cell measurement procedure for the virtual cell while operating in the idle or inactive mode according to the measurement configuration; and
transmitting a feedback report that indicates a result of the virtual cell measurement procedure.
